(19) United States
(12) Patent Application Publication
(10) Pub. No.: US 2026/0282047 A1
(43) Pub. Date: Sep. 17, 2026

(54) RESOURCE SELECTION FOR SIDELINK COMMUNICATION ON UNLICENSED BAND (SL-U)

(71) Applicant: Apple Inc., Cupertino, CA (US)

(72) Inventors: Huaning Niu, San Jose, CA (US); Zhibin Wu, Los Altos, CA (US); Wei Zeng, Saratoga, CA (US); Chunxuan Ye, San Diego, CA (US); Peng Cheng, Beijing (CN)

(21) Appl. No.: 19/472,142

(22) PCT Filed: Apr. 7, 2023
(86) PCT No.: PCT/CN2023/087094

§ 371 Date: Oct. 3, 2025

(51) Int. Cl. H04W 72/25; H04W 74/08

(52) U.S. Cl. CPC H04W 72/25; H04W 74/0866

(57) ABSTRACT

Some aspects of the present description relate to techniques of mode 2 resource selection for sidelink communication on an unlicensed bands (SL-U) based on a CCA operation. A transmitting UE performs the CCA operation and then select resources using a mode 2 sensing and resource selection procedure. The sensing algorithm starts by identifying potential candidate resources within a selection window. In some aspects, the selection window is bounded by an expected CCA time for a Type 1 CCA operation, such that the potential candidate resources are limited to time slots after an expected completion time of the Type 1 CCA operation. Thereby, transmission success rate of the SL-U transmission can be improved, since less transmission failure of incomplete CCA operation would occur.

### FIELD

This disclosure relates to wireless communication networks including techniques for sidelink communication on unlicensed band.

### BACKGROUND

The increased use of mobile applications has resulted in much focus on developing wireless systems capable of delivering large amounts of data at high speed. Sidelink (SL) communication can be used to facilitate direct device-to-device communication and to bypass and offload the base station and enables a quick exchange of data over a short period of time. Solutions for efficiency and reliability continue to evolve to include enhancements and new features.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a block diagram illustrating a plurality of user equipments (UEs) configured to perform sidelink communication on unlicensed bands (SL-U) in accordance with some aspects of the present description.

FIG. 2 is a schematic diagram illustrating timing for resource selection for SL-U in accordance with some aspects of the present description.

FIG. 3 is a schematic diagram illustrating timing for resource selection based on a clear channel assessment (CCA) for SL-U operation in accordance with some aspects of the present description.

FIG. 4 is a logic flow diagram illustrating a process to select and exclude resources based on a CCA operation for SL-U in accordance with some aspects of the present description.

FIG. 5 is a schematic diagram illustrating selecting and excluding resources based on a CCA operation for SL-U in accordance with some aspects of the present description.

FIG. 6 is a process flow diagram illustrating a process for a transmitting UE to perform sidelink communication on unlicensed bands (SL-U) in accordance with some aspects of the present description.

FIG. 7 is a logic flow diagram illustrating a process for a transmitting UE to receive shared Channel Occupancy Time (COT) information and select resources for SL-U in accordance with some aspects of the present description.

FIG. 8 is a schematic diagram illustrating timing for resource selection for SL-U in accordance with some aspects of the present description.

FIG. 9 is a process flow diagram illustrating a process for a transmitting UE to perform sidelink communication on unlicensed bands (SL-U) using a shared COT in accordance with some aspects of the present description.

FIG. 10 is a block diagram illustrating a device that can be employed to perform resource selection for SL-U with a CCA operation in accordance with some aspects of the present description.

FIG. 11 is a block diagram illustrating baseband circuitry that can be employed to perform resource selection for SL-U with a CCA operation in accordance with some aspects of the present description.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless communication networks may include user equipment (UEs) capable of communicating wirelessly with base stations and other network nodes and also UE-to-UE direct communication using sidelink signaling. For sidelink communication between UEs, the resource allocation may be performed using either mode 1 or mode 2. In mode 1, the network (e.g., a base station) allocates resources and communicates the resource allocation to the UEs via Uu operation, and the UEs transmit/receive sidelink signals using the allocated resources. In mode 2, a transmitting UE participating in sidelink communication may allocate resources autonomously and communicate data using the allocated resources to one or more other UEs. The sidelink resources may be determined based on a sensing and selection procedure, assisted by resource reservation announcement of other UEs. The resources may be selected and/or reserved from sidelink resource pools, which can be shared by multiple sidelink UEs.

In addition, sidelink transmissions may use unlicensed frequency bands for standalone operation or license-assisted access as complementary spectra for providing higher system capacity and transmission flexibility. To operate in the unlicensed frequency bands, the UEs may perform one or more clear channel assessment (CCA) operations in order to determine whether one or more channels in the unlicensed spectrum is unavailable or otherwise occupied prior to transmitting in the unlicensed spectrum. The CCA operations may be performed according to a listen-before-talk (LBT) protocol or other channel occupancy detection procedures. For example, a transmitting UE may listen to other potential transmission activities on a channel for a deferral duration before declaring the channel available, and then wait a back-off period prior to transmitting. The CCA operations help to coordinate spectra usage across multiple devices and even different radio-access technologies. However, the time needed for the CCA operations, for example, the deferral duration and the back-off period as mentioned, negatively affects successful selection of sidelink resources and thus may delay transmission of sidelink data. For example, the time slot for the resources selected by the transmitting UE may arrive before the CCA operations are completed, which would results in a failure of transmitting sidelink data using the selected resources.

Accordingly, some aspects of the present description relate to techniques of mode 2 resource selection for sidelink communication on an unlicensed bands (SL-U) based on a CCA operation. A transmitting UE performs the CCA operation and then select resources using a mode 2 sensing and resource selection procedure. The sensing algorithm starts by identifying potential candidate resources within a selection window. In some aspects, the selection window is bounded by an expected CCA time for a Type 1 CCA operation, such that the potential candidate resources are limited to time slots after an expected completion time of the Type 1 CCA operation. Thereby, transmission success rate of the SL-U transmission can be improved, since less transmission failure of incomplete CCA operation would occur. Additionally or alternatively, the selection window is bounded by a COT duration of a shared COT initiated by an initiating UE when selecting or reselecting resources for transmitting to the initiating UE using the shared COT. In some further aspects, the transmitting UE receives a consistent LBT failure indication from a higher layer and accordingly excludes the corresponding resources to form a set of adjusted (e.g., remaining) candidate resources. As such, efficiency of the resource selection and the subsequent SL-U transmission can be improved, since the busy channel is excluded without involving multiple separate CCA operations. Additional aspects and details of the disclosure are further described below with reference to figures.

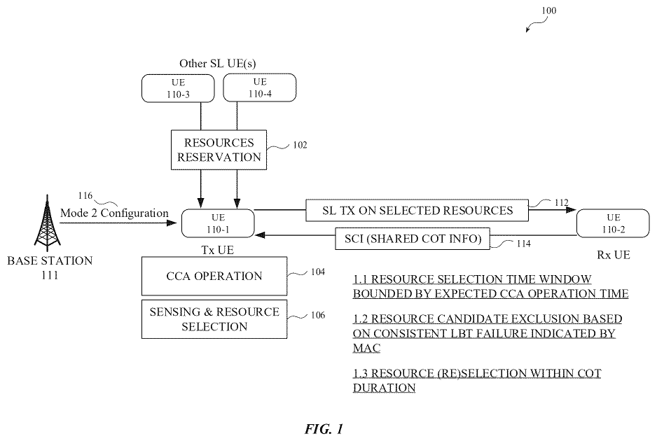

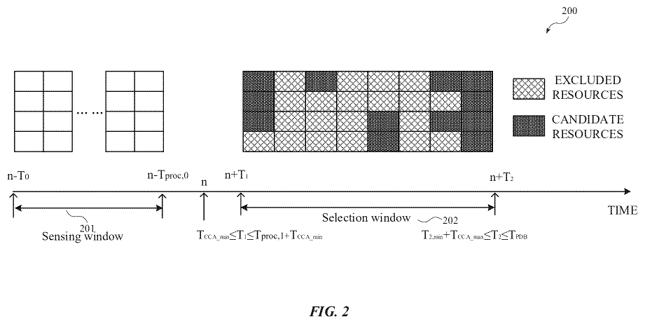

FIG. 1 is a block diagram illustrating systems and devices of an example network 100 including a plurality of UEs such as UE 110-1, UE 110-2, UE 110-3, UE 110-4 etc. (also referred as UEs 110 hereafter) configured to perform sidelink communication over unlicensed bands, and related methods and operations, in accordance with some aspects of the present description. The UEs 110 may also communicate and establish a connection with (e.g., be communicatively coupled with) a Radio Access Network (RAN) node such as a base station 111. The UE 110-1 is shown as a transmitting UE having sidelink data to be transmitted to a receiving UE such as the UE 110-2. In case of resource allocation Mode 2, the transmitting UE 110-1 autonomously decides on the resources to use for sidelink transmission based on a sensing and resource selection procedure 106, as will be described in more detail below and also associated with FIG. 2. The sensing and resource selection procedure 106 may be assisted by resource reservations 102 received from other UEs 110-2, 110-3, 110-4 etc. The resource reservations 102 may be broadcasted by the other UEs 110-2, 110-3, 110-4 as part of a first stage SCI transmitted over a physical sidelink control channel (PSCCH). The resources may be reserved and/or selected from sidelink resource pools, which can be shared by multiple UEs 110.

The UEs 110 communicate with one another, over a licensed medium (also referred to as the “licensed spectrum” and/or the “licensed band”), an unlicensed medium (also referred to as the “unlicensed spectrum” and/or the “unlicensed band”), or the combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, the UEs 110 and the base station 111 may operate standalone or using licensed assisted access (LAA), eLAA, and/or feLAA mechanisms. In these implementations, the transmitting UE 110-1 may perform a CCA operation 104, such as various types of medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol and other procedures.

As shown by act 112, the transmitting UE 110-1 then transmits the sidelink data to the receiving UE 110-2 over the selected resources. The sidelink data is transmitted as transport blocks (TBs) carried on a physical sidelink shared channel (PSSCH). A TB is associated with a SCI. The SCI indicates the resources used by the PSSCH that carries the associated TB and further information for decoding the TB. The SCI may be transmitted in the same slot as the sidelink data and is in two stages. A 1^{st} stage SCI is carried on a physical sidelink control channel (PSCCH) while a 2^{nd} stage SCI is carried on the corresponding PSSCH carrying the TB. The 2^{nd} stage SCI enables a flexible SCI design to support unicast, group-cast, and broadcast transmissions. Splitting the SCI in two stages allows other UEs (e.g. the UEs 110-3, 110-4) to decode only the 1^{st} stage SCI for channel sensing purposes, to determine resources reserved the transmitting UE 110-1. On the other hand, the 2^{nd} stage SCI provides additional control information as required for the transmission to the receiving UE 110-2.

As shown by act 114, in some aspects, the transmitting UE 110-1 may receive a shared COT information initiated by another UE such as the UE 110-2 as an initiating UE of a shared COT to be potentially shared by the UE 110-1 and/or other COT sharing candidate UEs such as the UEs 110-3, 110-4. The shared COT information is transmitted together with a data payload from the UE 110-2 to the UE 110-1. The shared COT information indicates parameters of the shared COT, such as a duration of the COT, a UE identity of the initialing UE, and a channel access priority class (CAPC) value for granting the COT (CAPC-COT). The shared COT information may be transmitted on a 1^{st} stage SCI carried on a PSCCH and broadcasted or group-casted to multiple UEs such as the UEs 110-1, 110-3, 110-4. The data payload is carried on a PSSCH and may be transmitted to the UE 110-1 in the same slot as the PSCCH carrying the shared COT information.

As indicated by a first indicator 1.1 and further discussed associated with FIG. 2 and other figures herein, in some aspects, an expected time period to perform the CCA operation 104 is used to bound a resource selection window for the sensing and resource selection procedure 106. Specifically, a start time of the resource selection window accommodates a minimum expected time period for the CCA operation 104 (“T_{CCA_min}”), while an ending time of the resource selection window accommodates a maximum expected time period for the CCA operation 104 (“T_{CCA_max}”). T_{CCA_min} and T_{CCA_max} are calculated based on a channel access priority class (CAPC) value of the sidelink data to be transmitted and a current contention window size (“CW_p”) of the CCA operation 104. In some further aspects, the CCA operation 104 comprises determining a channel occupancy rate Roc, and T_{CCA_min} and T_{CCA_max} are calculated further based on the channel occupancy rate.

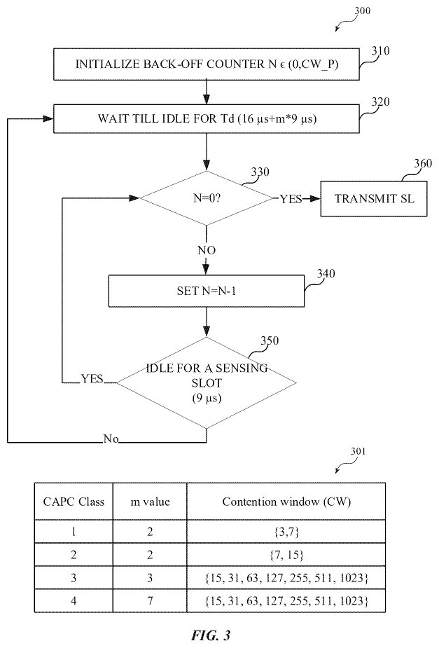

As indicated by a second indicator 1.2 and further discussed associated with FIG. 3 and other figures herein, in some aspects, a channel occupancy condition determined by the CCA operation 104 is used to exclude resources during the sensing and resource selection procedure 106. Specifically, information of resource block set with consistent LBT failure is acquired and indicated from a MAC layer to a physical layer of the transmitting UE 110-1, and the resource block set is excluded from an initial set of candidate resources “SA”.

As shown by a third indicator 1.3 and further discussed associated with FIG. 2 and other figures herein, in some aspects, the resource selection is performed based on the parameters of the COT, if the transmitting UE 110-1 shares the COT with the receiving UE 110-2,. For example, the resource selection window (e.g. the selection window 202 in FIG. 2) is bounded by a COT duration of the COT, such that the SL transmission can be timely transmitted and completed during the COT.

Additionally, the base station 111 may be configured to wirelessly communicate with the UEs 110 and may provide the UEs 110 Mode 2 sidelink resource allocation configurations, as shown by act 116. These configurations are intended to optimize the use of available resources and ensure that the UEs 110 can communicate with each other reliably and efficiently. For example, the base station 111 may configure the size and number of resource blocks that are available for use by the UEs 110. This can include setting aside specific resource blocks for particular use cases, such as emergency services or specific kind of communication.

The base station 111 may also configure the sidelink channel such as selecting the frequency band, bandwidth, and modulation scheme used for sidelink communication. The base station 111 may also configure the maximum transmission power that the UEs 110 can use for sidelink communication. This helps to prevent interference with other devices and ensure that the network operates efficiently.

The UEs 110 may comprise types of mobile or non-mobile computing devices, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, Machine Type Communication (MTC) devices, Machine to Machine (M2M), Internet of Things (IoT) devices, and/or the like.

The systems and devices of example network 100 may operate in accordance with one or more communication standards, such as 4th generation (4G) (e.g., long-term evolution (LTE)), 5th generation (5G) (e.g., new radio (NR)), and/or other communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, etc.), institute of electrical and electronics engineers (IEEE) standards (e.g., wireless metropolitan area network (WMAN), worldwide interoperability for microwave access (WiMAX), etc.), and more.

In some aspects, the RAN node such as the base station 111 can be a next generation (NG) RAN or a 5G RAN, an evolved-UMTS Terrestrial RAN (E-UTRAN), or a legacy RAN, such as a UTRAN or GERAN. As used herein, the term “NG RAN” or the like can refer to a RAN node that operates in an NR or 5G system, and the term “E-UTRAN” or the like can refer to a RAN node that operates in an LTE or 4G system. The RAN node may be further connected to a core network (CN) via an NG interface. The CN may comprise a plurality of network elements, which are configured to offer various data and telecommunications services to customers/subscribers (e.g., users of UEs 110) who are connected to the CN via the RAN.

FIG. 2 is a schematic diagram 200 illustrating resource selection for a sidelink data transmission over unlicensed bands in accordance with some aspects of the present description. As described above associated with the sensing and resource selection procedure 106, in mode 2 resource allocation, a transmitting UE (e.g., the transmitting UE 110-1 in FIG. 1) participating in sidelink communication may allocate resources autonomously for transmission and re-transmission if the resources are not in use by other UEs with higher priority traffic, determined by a sensing procedure performed within a sensing window 201. The transmitting UE may then select and occupy resources within a selection window 202 for an appropriate amount of time until a re-selection event is triggered.

The sensing procedure starts by the transmitting UE determining the selection window and all potential candidate resources within the selection window 202. The selection of resources by the transmitting UE for its (re-)transmission is based on the sensing results during the sensing window 201 for the potential candidate resources within the selection window 202. The selection window 202 is determined to be bounded to a time frame (n+T1, n+T2), where n is a trigger time for resource allocation, and n+T1 is the lower bound of the selection window 202, and n+T2 is the upper bound of the selection window 202. As an example, the trigger time n can be an arrival time of a transport block. There are two processing times (Tproc0 and Tproc1) before and after the trigger time n, which may respectively refer to the required time in the physical and MAC layers for processing an inter-layer information exchange and preparing sidelink physical channels. In the mode 2 of resource allocation, the transmitting UE may perform continuous sensing. When a resource selection event is triggered at the trigger time n in the transmitting UE, it considers its recent sensing results within the sensing window 201 (e.g., between 1100 ms and 100 ms) prior to the trigger time n for resource selection. The sensing results at a further bound n-To (e.g., 1100 ms) of the sensing window 201 are beneficial to identify the reserved resources by other UEs for periodic traffic, and the sensing results at a closer bound n-Tproc, 0 (e.g., 100 ms) of the sensing window 201 are particularly useful for non-Periodic traffic.

In some aspects, the lower bound n+T1 of the selection window 202 is determined considering a minimum expected CCA time T_{CCA_min}, such that the resource candidates can be restricted to resource candidates after the CCA operation is completed, and thus the success rate of SL-U transmission is increased. As an example, the lower bound n+T1 may be determined as T_{CCA_min}≤T1≤Tproc,1+T_{CCA_min}. Tproc,1 is the processing time required for resource selection for sidelink transmission and may be in slots or in time. For example, Tproc,1 can be equal to 3, 5, 9, or 17 slots for a sub-carrier spacing (SCS) of 15, 30, 60, or 120 kHz, respectively. TCCA_min may be calculated based on a channel access priority class (CAPC) value of the sidelink data to be transmitted and a current contention window size (“CW_p”) of the CCA operation. In some further aspects, a channel occupancy rate Roc is also included in calculating T_{CCA_min}.

In some aspects, the upper bound n+T2 of the selection window 202 is determined considering a maximum expected CCA time T_{CCA max}, such that the resource candidates can be extended considering the time the CCA operation takes, and thus availability and efficiency of resource selection is increased. As an example, the upper bound n+T2 may be determined as T_{2,min}+T_{CCA_max}≤T2≤T_{PDB}, where T_{2,min} is a predefined or preconfigured time parameter for minimum selection period, and T_{PDB} is the remaining packet delay budget (PDB) used for meeting latency requirement. For example, T_{2,min} can be equal to 1, 5, 10, or 20 slots. T_{2,min} may also be defined in time instead of slots. T_{CCA_max} may be calculated based on the CAPC value of the sidelink data to be transmitted and the current contention window size (“CW_p”) of the CCA operation. In some further aspects, the channel occupancy rate Roc is also included in calculating T_{CCA_max}. More details of the expected CCA times T_{CCA_min} and T_{CCA_max} are described below associated with a diagrams of FIG. 3.

FIG. 3 shows a schematic diagram illustrating timing for resource selection based on a clear channel assessment (CCA) for SL-U operation in accordance with some aspects of the present description. The CCA operation helps to coordinate spectra usage across multiple devices and even different radio-access technologies. There are different types of CCA operations for various communication schemes. Type 1 CCA is used to initiate one or more transmission within the same channel occupancy time (COT), while Type 2 CCA is used for COT sharing and transmission of discovery burst. Type 2 CCA includes Type 2A, 2B, or 2C performed depending on a length of a COT gap between transmissions. Type 2A CCA is performed when the COT gap is equal to or greater than 25 μs and for transmission of the discovery burst. Type 2B CCA is performed when the COT gap is equal to or greater than 16 μs but less than 25 μs. Type 2C CCA is performed when the COT gap is less than 16 μs.

When the CCA operation is Type 1 CCA, the transmitting UE may listen to other potential transmission activities on a channel for a deferral duration T_{d} before declaring the channel available, and then wait a back-off period prior to transmitting. An example Type 1 CCA operation may include steps shown in a logic diagram 300:
1) Initialize a back-off counter N with a random value uniformly distributed between 0 and the current contention window size (“CW_p”), as shown by act 310;
2) Wait until channel is idle for the deferral duration Td (e.g. 16 μs+m*9 μs), as shown by act 320;
3) Determine if N equals to 0, as shown by act 330;
4) If N=0, the transmitting UE is ready to transmit sidelink data as scheduled, as shown by act 360;
5) If N>0, set N=N−1, as shown by act 340; and
6) Following the decrement of the back-off counter N, sense the channel for an additional sensing slot duration (e.g., 9 μs) as shown by act 350. If the additional sensing slot duration is idle, go to act 330 to determine if N decreases to 0; else, go to act 320 to wait for the channel to become clear/idle for another deferral duration Td.

The deferral duration Ta depends on priority of the data. As an example, the deferral duration T_{d} consists of a fixed time period Tf (e.g. 16 μs) and an integer number m of multiples of sensing slot durations (e.g. m*9 μs). The number m may be related to the CAPC value of the data to be transmitted. Table 301 shows an example of m values and allowed CW sizes for corresponding CAPC classes. Thus, high-priority traffic (of a smaller CAPC value) senses the channel for a shorter period of time Td and thus can grab the channel quicker than low-priority traffic. The back-off counter N is randomly selected by the CCA operation between 0 and the current contention window size (“CW_p”) to avoid collisions between multiple transmitters. Without the random back-off, two UEs waiting for the channel to become available would start at the same time, resulting in a collision. With the random back-off, the likelihood of multiple UEs trying to access the channel simultaneously is greatly reduced. Also, high-priority traffic (of smaller CAPC value) uses a smaller CW to get faster access to the channel while low-priority traffic uses a larger CW, increasing the likelihood of the high-priority traffic transmitted before the low-priority traffic. The size of the current contention window CW_p is adjusted based on an acknowledge/non-acknowledge (ACK/NACK) feedback. For example, the CW_p may be set to its minimum value after receiving a positive ACK/NACK feedback, and may be doubled up to the maximum limit if receiving a negative ACK/NACK. Thus, the channel is more aggressively used for efficiency if transmission succeeds and less aggressively used to reduce collisions with other transmissions if transmission fails.

Thus, in some aspects, the minimum expect CCA time, T_{CCA_min} described above, consists of the deferral duration Td and a back-off duration Tb. For example, T_{CCA_min} is set to Td+Tb, where Td is 16 μs+m*9 μs. However, the estimated back-off duration Tb depends upon individual transmission conditions. Assuming all sensing slots were sensed idle during the act 350 of the Type 1 CCA operation shown in a logic diagram 300, the estimated back-off duration Tb is N*9 μs. Thus, T_{CCA_min} can be set to 16 μs+m*9 μs+N*9 μs. However, in various user cases, busier channel would result in a longer back-off duration Tb, as the channel may be sensed as occupied by the act 350 and thus takes longer CCA operation. Accordingly, in some further aspects, the estimation of expected back-off duration Tb may be enhanced by involving a channel occupancy rate Roc, which indicates a ratio of sensing slots that is deemed busy/occupied. As an example, T_{CCA_min} can be set to 16 μs+m*9 μs+N*9 μs/(1−Roc).

In one aspect, a received signal strength indicator (RSSI) measurement is performed for sidelink transmission. The RSSI measurement may be configured or preconfigured by a base station with a channel occupancy threshold (e.g. channelOccupancyThreshold) and a measurement window (e.g. reportInterval). The configurations may be included as a part of the report configuration (e.g. the RRC IE reportConfig). The channel occupancy rate Roc is defined using the RSSI measurement results. Specifically, the channel occupancy rate Roc is defined as a percentage of samples with a RSSI higher than the channel occupancy threshold, measured in the measurement window. For example, the channel occupancy rate Roc can be a percentage of samples with a power level of a received signal greater than a configurable threshold (e.g., configured in a range of 0 to −76 dBm) or preconfigured to a predefined value (e.g., −72 dBm), within a configurable measurement window, for example, 160 ms.

In some alternative aspects, the channel occupancy rate Roc is defined using measurement results of the CCA operation. Specifically, the channel occupancy rate Roc is defined as a percentage of sensing slots that are identified as busy/occupied slots among the total sensing slots within a predefined time window. For example, if 9 sensing slots are identified as busy slots within a time window of 20 sensing slots, the channel occupancy rate Roc is 45%. A sensing slot may be identified as busy/occupied if a received energy during at least 4 μs of a 9 μs sensing slot meets a threshold.

Similarly, the maximum CCA time T_{CCA_max} as described above, can also be set to Td+Tb, with Td being 16 μs+m*9 μs and Tb estimated as N*9 μs in some aspects and N*9μs/(1−Roc) in some alternative aspects. The expected back-off duration Tb may be further extended to the current contention window CW_p, or additionally factoring in the channel occupancy rate Roc as CW_p/(1−Roc), such that more potentially available candidate resources can be included in resource selection. Thus, the maximum CCA time T_{CCA_max} may be set to 16μs+m*9 μs+CW_por 16 μs+m*9 μs+CW_p/(1−Roc).

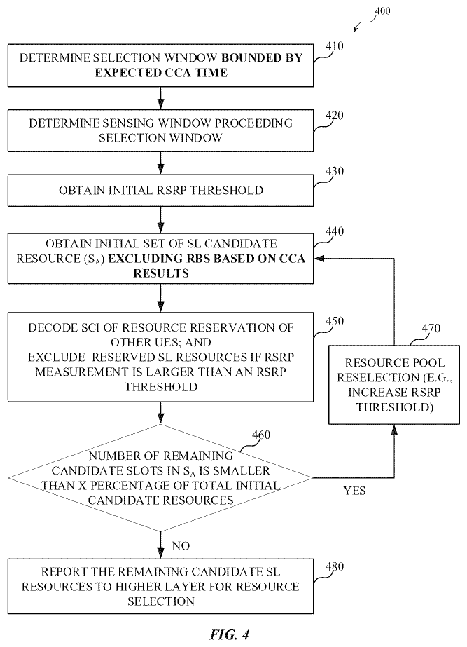

FIG. 4 shows a logic flow diagram 400 illustrating a process to select and exclude resources based on a CCA operation for SL-U in accordance with some aspects of the present description. As show by act 410, a selection window is determined, and potential candidate resources within the selection window are identified. The determination of the selection window has been described above associated with FIGS. 1-3. The selection window, represented by (n+T1, n+T2), is bounded by an expected CCA time for a Type 1 CCA operation, such that the potential candidate resources are limited to the time slots after expected completion of the Type 1 CCA operation. Thereby, transmission success rate of the SL-U transmission can be improved.

As show by act 420, a sensing window proceeding the selection window is determined. The sensing window, represented by (n−T0, n−T_{proc,0}), is used for receiving channel occupancy information, such as resource reservations by other UEs. The sensing results at a further bound n−T₀ (e.g., 1100 ms) of the sensing window are beneficial to identify the reserved resources by other UEs for periodic traffic, and the sensing results at a closer bound n−T_{proc,0}(e.g., 100 ms) of the sensing window are particularly useful for non-periodic traffic.

As show by acts 430 to 470, resource reservations received from other UEs during the sensing window are decoded to be excluded from the candidate resources if certain criteria is met. As shown by act 430, the UE obtains an initial RSRP threshold. In some aspects, the initial RSRP threshold is configured or pre-configured on a per resource pool basis. In some additional or alternative aspects, the initial RSRP threshold is based on a priority prio_TX of transmit data. For example, if the transmit data has a high priority, a higher initial RSRP threshold may be used. The higher RSRP threshold results in less candidate resources being excluded from selection, thus, more adjusted candidate resources are available. Conversely, if the transmit data has a low priority, a lower initial RSRP threshold may be used.

As shown by act 440, the UE obtains an initial set of candidate resources “S_{A}” for SL-U transmission. In some aspects, the UE excludes resources overlapped with RB set with consistent LBT failure from the initial candidate resources S_{A} to form a set of adjusted (e.g., remaining) candidate resources. The RB set with consistent LBT failure is indicated to the physical layer from a higher layer (e.g., MAC layer). Consistent LBT failure is detected and indicated per RB set by counting LBT failure indications for SL-U transmissions from the physical layer to the MAC layer. Then, a consistent LBT failure is determined by the MAC layer upon the LBT failure indications reach a (pre)configured threshold. The MAC entity may be configured by RRC with a consistent LBT failure recovery procedure. RRC configures the parameters used for detection of consistent sidelink LBT failures for operation with shared spectrum channel access. For example, a maximum LBT failure count (lbt-FailureInstanceMaxCount) and a failure detection timer (e.g. lbt-FailureDetectionTimer) can be configured in a failure recovery configuration (e.g., lbt-FailureRecoveryConfig) and used for determine the consistent LBT failure.

As shown by act 450, the set of adjusted (e.g., remaining) candidate resources is further filtered to exclude resources if the UE received SCI reserving the resources during the sensing window, and if an RSRP associated with the SCI is greater than the RSRP threshold. In some additional or alternative aspects, the initial RSRP threshold is based on a priority prio_RX of SCI received from another UE. For example, if the UE received SCI from another UE (e.g., during the sensing window) reserving resources with a high priority, then the UE may use a lower RSRP threshold initially. Consequently, the high priority resources are more likely to be excluded from resource selection, thereby reducing interference with the high priority transmission of another UE. Alternatively, if the UE only received SCI from other UEs reserving resources for SL-PRS with low priorities, then the UE may choose to use a higher initial RSRP threshold, such that the resources are more likely as available candidate resources.

As shown by act 460, if the set of adjusted candidate resources is smaller than a threshold percentage “X” of the initial candidate resources S_{A}, the resource pool is rearranged as shown by act 470, and the MAC layer then selects resource with the updated resource pool. As an example of rearranging resource pool, the RSRP threshold is increased by an RSRP adjustment value and the process is repeated. Otherwise, the adjusted candidate resources are reported to a higher layer (e.g., MAC layer) for subsequent resource selection and SL-U data transmission, as shown by act 480. The threshold percentage value X may be either configured, or pre-configured. For example, after the exclusion of reserved resources from the selection window (as shown and described associated with acts 440 and 450), the MAC layer may select resources from the set of adjusted candidate resources. The selection may be random, or based on timing, traffic priority, and/or measurement conditions. For example, resources can be randomly selected from 20% of the best resources with a measured RSRP less than the (pre)configured threshold and based on the traffic priority. If the remaining resources after the exclusion procedures of acts 440 and 450 are less than 20% of the all resources in the selection window, then the UE relaxes the RSRP threshold (by 3 dB) until it has at least 20% (or 35, 50% based on traffic priority) of all resources in the selection window for resource allocation. The final selection of resources is done in the MAC layer of a UE receiving a set of unoccupied resources from the physical layer.

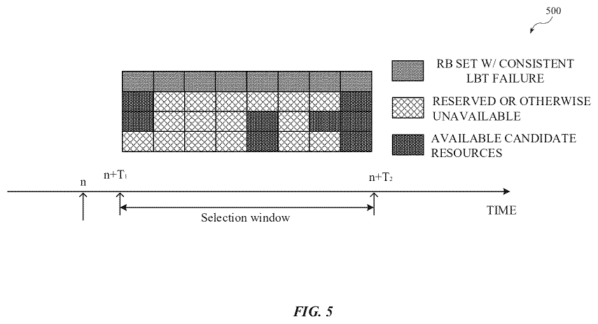

FIG. 5 shows a schematic diagram 500 of a resource pool within a selection window illustrating selecting and excluding resources based on a CCA operation for SL-U in accordance with some aspects of the present description. In some aspects, if the UE receives information about a RB set with consistent LBT failure, as described above associated with act 440 of FIG. 4, the RB set is excluded from the resource pool. In some aspects, the RB set is identified as covering one or more sub-channel frequencies and not restricted in time. Thus, multiple time slots can be excluded from potential candidate resources without needing multiple CCA operations.

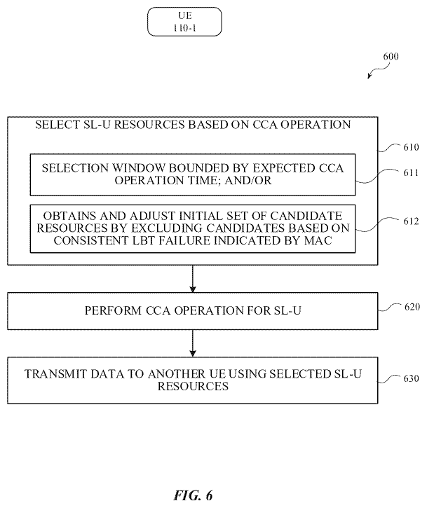

FIG. 6 is a process flow diagram 600 illustrating a process for a transmitting UE (e.g. the transmitting UE 110-1 as described throughout the description) to perform communication on SL-U based on a CCA operation in accordance with some aspects of the present description.

As shown by act 610, the transmitting UE senses resource reservations from other UEs and selects resources for SL-U transmission. The selection of the resources may consider parameters and conditions of a CCA operation to be performed. In one aspect, as shown by act 611, the determination of a selection window considers an expected CCA operation time that the CCA operation may take. As described above, for Type 1 CCA, the expected CCA operation time includes a deferral duration Td and a back-off period Tb. The deferral duration T_{d} depends on priority of the data. As an example, the deferral duration T_{d} may consists of a fixed time period Tf (e.g. 16 μs) and an integer number m of multiples of sensing slot durations (e.g. m*9 μs). The number m may be related to the CAPC value of the data to be transmitted. The estimated back-off duration Tb depends upon individual transmission conditions. Assuming all sensing slots were clear during the Type 1 CCA operation, the estimated back-off duration Tb is N*9 μs, with N being a integer number randomly picked between 0 and a current contention window. Thus, a minimum expected CCA operation time, T_{CCA_min}, can be set to 16 μs+m*9 μs+N*9 μs. However, in various user cases, busier channel would result in a longer back-off duration Tb, as the channel may be sensed as occupied and thus result longer CCA operation.

Accordingly, in some further aspects, the estimation of expected back-off duration Tb may be enhanced by involving a channel occupancy rate Roc, which indicates a ratio of sensing slots that is deemed busy/occupied. As an example, T_{CCA_min} can be set to 16 μs+m*9 μs+N*9 μs/(1−Roc). T_{CCA_min} can be used to limit a lower bound of the selection window, such that failure of transmission because of incompleteness of the CCA operation is reduced. In another aspect, as shown by act 612, the candidate resource set may be adjusted by excluding candidates based on consistent LBT failure. One or more RB sets with consistent LBT failure are indicated to the physical layer from a higher layer (e.g., MAC layer). Consistent LBT failure is detected and indicated per RB set by counting LBT failure indications from the physical layer to the MAC layer. Then, a consistent LBT failure is determined by the MAC layer upon the LBT failure indications reach a (pre)configured threshold.

As shown by act 620, the CCA operation for SL-U is performed. The CCA operation can be a Type 1 CCA for initiating one or more transmission within the same channel occupancy time (COT). Alternatively or additionally, the CCA operation can comprise Type 2 CCA used for COT sharing and transmission of discovery burst. Type 2 CCA includes Type 2A, 2B, or 2C performed depending on a length of a COT gap between transmissions. Type 2A CCA is performed when the COT gap is equal to or greater than 25 μs and for transmission of the discovery burst. Type 2B CCA is performed when the COT gap is equal to or greater than 16 μs but less than 25 μs. Type 2C CCA is performed when the COT gap is less than 16 μs. When the CCA operation is Type 1 CCA, the transmitting UE may listen to other potential transmission activities on a channel for a deferral duration Td before declaring the channel available, and then wait a back-off period Tb prior to transmitting.

As shown by act 630, after selecting resources, the transmitting UE transmits data to another UE using the selected resources for the SL-U.

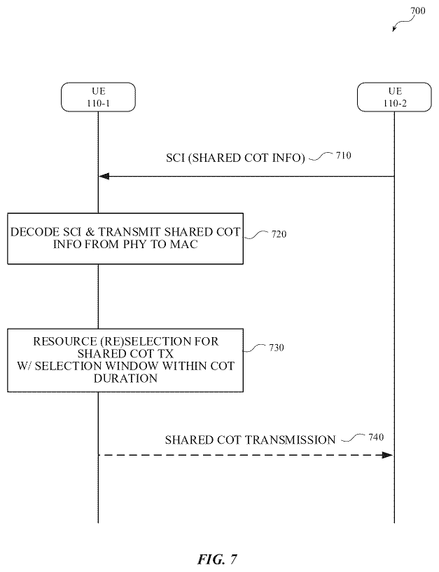

FIG. 7 is a logic flow diagram 700 illustrating a process for a transmitting UE (e.g. the transmitting UE 110-1 as described throughout the description) to receive shared Channel Occupancy Time (COT) information and select resources for SL-U in accordance with some aspects of the present description.

At act 710, a shared Channel Occupancy Time (COT) information is transmitted from the UE 110-2 as an initialing UE to the transmitting UE 110-1. The shared COT information includes information of a shared COT initiated by the initialing UE. In some aspects, the shared COT information comprises one or more of a duration of the COT, a UE identity of the initialing UE 110-2. In some aspects, the shared COT information may further comprise a priority threshold to use the COT. In some aspects, the shared COT information is transmitted with a Sidelink Control Information (SCI) format. The shared COT information may be transmitted on a Physical Sidelink Control Channel (PSCCH). In some aspects, the shared COT information may be exclusively communicated between the initialing UE 110-2 and the transmitting UE 110-1 (unicast). In other aspects, the initialing UE 110-2 may send the shared COT information to be received by all candidate UEs within the radio transmission range of the initialing UE 110-2 (broadcast), or send the shared COT information to be received by a set of receivers which fulfill certain conditions (group cast).

At act 720, the SCI including the shared COT information may be decoded and sent from a physical layer to a MAC layer of the UE 110-1. A determination is made on whether the UE 110-1 could share the COT based on the shared COT information, and for example, by assessing availability and priority of MAC-CEs and/or logic channels for the UE 110-1 and/or other candidate UEs based on the shared COT information.

At act 730, a resource is selected or reselected for shared COT transmission from the transmitting UE 110-1 to the initiating UE 110-2. A resource selection window for SL-U has a start time and an ending time. The ending time is not later than a remaining COT duration of the COT or a remaining PDB duration.

At act 740, data is transmitted from the UE 110-1 to the UE 110-2 using the selected or reselected resources over the shared COT.

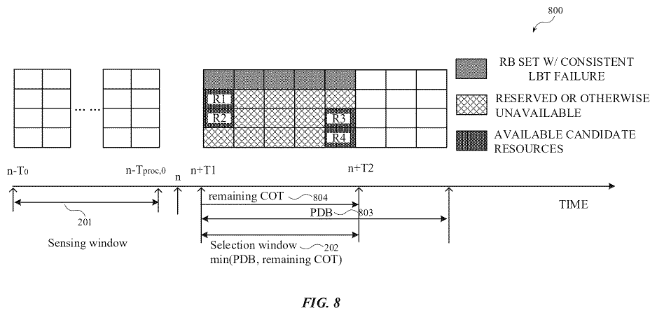

FIG. 8 shows a schematic diagram 800 of a resource pool within a selection window 202 illustrating a transmitting UE (e.g. the transmitting UE 110-1 as described throughout the description) to select resources for SL-U transmission using a shared COT in accordance with some aspects of the present description. Additionally or alternatively to various limitations of the sensing window as already described, in some aspects, the selection window 202 is also bounded to a remaining COT duration 804. Thus, in some aspects, the selection window 202 is determined as a minimum of a PDB 803 and the remaining COT duration 804. As such, the selection window 202 is limited by the remaining COT duration 804, such that the sidelink transmission for the initialing UE can be completed during the remaining COT duration 804. The resource selection may be random, or based on timing, traffic priority, and/or measurement conditions. For example, resources can be randomly selected from the available candidate resources (e.g. R1, R2, R3, and R4 in the figure). Alternatively, earlier resources (e.g. R1, R2) can be selected over later resources (e.g. R3, R4) to better use the shared COT. If the remaining resources after the exclusion procedures are less than a threshold, a resource pool rearrangement may be performed as described above.

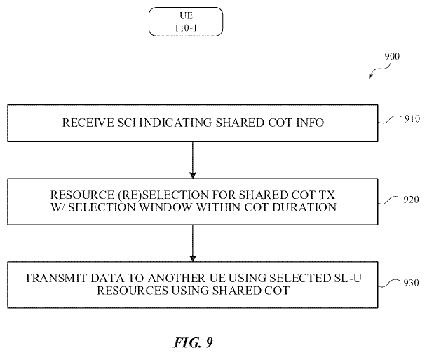

FIG. 9 shows a process flow diagram 900 illustrating a process for a transmitting UE (e.g. the transmitting UE 110-1 as described throughout the description) to transmit data on SL-U using a shared COT in accordance with some aspects of the present description.

As shown by act 910, a shared Channel Occupancy Time (COT) information is received from an initialing UE to the transmitting UE. The shared COT information includes information of a shared COT initiated by the initialing UE. In some aspects, the shared COT information comprises one or more of a duration of the COT, a UE identity of the initialing UE. In some aspects, the shared COT information is transmitted with a Sidelink Control Information (SCI) format. The shared COT information may be transmitted on a Physical Sidelink Control Channel (PSCCH). The shared COT information may be decoded and sent from a physical layer to a MAC layer. A determination is made on whether the transmitting UE could use the shared COT based on the shared COT information, and for example, by assessing availability and priority of MAC-CEs and/or logic channels for the transmitting UE based on the shared COT information.

As shown by act 920, if determined that the transmitting UE can use the shared COT, a resource is selected or reselected for shared COT transmission from the transmitting UE to the initiating UE. A resource selection window is determined with an ending time no later than a remaining COT duration of the COT or a remaining a remaining PDB duration.

As shown by act 930, data is transmitted from the transmitting UE to the initiating UE using the selected or reselected resources over the shared COT.

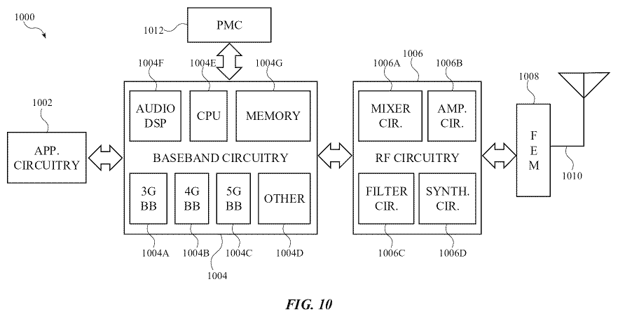

FIG. 10 is a diagram of an example of components of a device 1000 according to one or more implementations described herein. The device 1000 or its components can also be or be included in a UE such as the transmitting UE 110-1 as described throughout this disclosure. As described, the device 1000 may be configured to performing a sensing and resource (re)selection procedure based on a CCA operation including setting a selection window considering expected CCA operation time and/or excluding RBs experiencing consistent LBT failure as indicated by the MAC layer. In some alternative or additional aspects, the device 1000 receives a shared COT information from a COT sharing initiating device and performs a resource selection/reselection procedure with a selection window bounded by a remaining duration of the shared COT. The device 1000 may then transmit to the initiating device on SL-U using the shared COT after type 2A/2B/2C CCA.

In some implementations, the device 1000 can include application circuitry 1002, baseband circuitry 1004, RF circuitry 1006, front-end module (FEM) circuitry 1008, one or more antennas 1010, and power management circuitry (PMC) 1012 coupled together at least as shown. In some implementations, the device 1000 can include fewer elements (e.g., a RAN node may not utilize application circuitry 1002, and instead include a processor/controller to process IP data received from a CN such as 5GC or an Evolved Packet Core (EPC)). In some implementations, the device 1000 can include additional elements such as, for example, memory/storage, display, camera, sensor (including one or more temperature sensors, such as a single temperature sensor, a plurality of temperature sensors at different locations in device 1000, etc.), or input/output (I/O) interface. In other implementations, the components described below can be included in more than one device (e.g., said circuitries can be separately included in more than one device for Cloud-RAN (C-RAN) implementations).

The application circuitry 1002 can include one or more application processors. For example, the application circuitry 1002 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1000. In some implementations, processors of application circuitry 1002 can process IP data packets received from a CN.

The baseband circuitry 1004 can include circuitry such as, but not limited to, one or more single-core or multi-core processors. The baseband circuitry 1004 can include one or more baseband processors or control logic to process baseband signals received from a receive signal path of the RF circuitry 1006 and to generate baseband signals for a transmit signal path of the RF circuitry 1006. Baseband circuitry 1004 can interface with the application circuitry 1002 for generation and processing of the baseband signals and for controlling operations of the RF circuitry 1006. For example, in some implementations, the baseband circuitry 1004 can include a 3G baseband processor 1004A, a 4G baseband processor 1004B, a 5G baseband processor 1004C, or other baseband processor(s) 1004D for other existing generations, generations in development or to be developed in the future (e.g., 2G, 6G, etc.). The baseband circuitry 1004 (e.g., one or more of baseband processors 1004A-D) can handle various radio control functions that enable communication with one or more radio networks via the RF circuitry 1006. In other implementations, some or all of the functionality of baseband processors 1004A-D can be included in modules stored in the memory 1004G and executed via a Central Processing Unit (CPU) 1004E. The radio control functions can include, but are not limited to, signal modulation/demodulation, encoding/decoding, radio frequency shifting, etc. In some implementations, modulation/demodulation circuitry of the baseband circuitry 1004 can include Fast-Fourier Transform (FFT), precoding, or constellation mapping/de-mapping functionality. In some implementations, encoding/decoding circuitry of the baseband circuitry 1004 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 1004 can include one or more audio digital signal processor(s) (DSP) 1004F. The audio DSPs 1004F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1004 and the application circuitry 1002 can be implemented together such as, for example, on a system on a chip (SOC).

In some implementations, the baseband circuitry 1004 can provide for communication compatible with one or more radio technologies. For example, in some implementations, the baseband circuitry 1004 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1004 is configured to support radio communications of more than one wireless protocol can be referred to as multi-mode baseband circuitry.

RF circuitry 1006 can enable communication with wireless networks using modulated electromagnetic radiation through a non-solid medium. In various implementations, the RF circuitry 1006 can include switches, filters, amplifiers, etc. to facilitate the communication with the wireless network. RF circuitry 1006 can include a receive signal path which can include circuitry to down-convert RF signals received from the FEM circuitry 1008 and provide baseband signals to the baseband circuitry 1004. RF circuitry 1006 can also include a transmit signal path which can include circuitry to up-convert baseband signals provided by the baseband circuitry 1004 and provide RF output signals to the FEM circuitry 1008 for transmission.

In some implementations, the receive signal path of the RF circuitry 1006 can include mixer circuitry 1006A, amplifier circuitry 1006B and filter circuitry 1006C. In some implementations, the transmit signal path of the RF circuitry 1006 can include filter circuitry 1006C and mixer circuitry 1006A. RF circuitry 1006 can also include synthesizer circuitry 1006D for synthesizing a frequency for use by the mixer circuitry 1006A of the receive signal path and the transmit signal path. In some implementations, the mixer circuitry 1006A of the receive signal path can be configured to down-convert RF signals received from the FEM circuitry 1008 based on the synthesized frequency provided by synthesizer circuitry 1006D. The amplifier circuitry 1006B can be configured to amplify the down-converted signals and the filter circuitry 1006C can be a low-pass filter (LPF) or band-pass filter (BPF) configured to remove unwanted signals from the down-converted signals to generate output baseband signals. Output baseband signals can be provided to the baseband circuitry 1004 for further processing. In some implementations, the output baseband signals can be zero-frequency baseband signals, although this is not a requirement. In some implementations, mixer circuitry 1006A of the receive signal path can comprise passive mixers, although the scope of the implementations is not limited in this respect.

FEM circuitry 1008 can include a receive signal path which can include circuitry configured to operate on RF signals received from one or more antennas 1010, amplify the received signals and provide the amplified versions of the received signals to the RF circuitry 1006 for further processing. FEM circuitry 1008 can also include a transmit signal path which can include circuitry configured to amplify signals for transmission provided by the RF circuitry 1006 for transmission by one or more of the one or more antennas 1010. In various implementations, the amplification through the transmit or receive signal paths can be done solely in the RF circuitry 1006, solely in the FEM circuitry 1008, or in both the RF circuitry 1006 and the FEM circuitry 1008.

In some implementations, the PMC 1012 can manage power provided to the baseband circuitry 1004. In particular, the PMC 1012 can control power-source selection, voltage scaling, battery charging, or DC-to-DC conversion. The PMC 1012 can often be included when the device 1000 is capable of being powered by a battery, for example, when the device is included in a UE. The PMC 1012 can increase the power conversion efficiency while providing desirable implementation size and heat dissipation characteristics. While FIG. 10 shows the PMC 1012 coupled only with the baseband circuitry 1004. However, in other implementations, the PMC 1012 may be additionally or alternatively coupled with, and perform similar power management operations for, other components such as, but not limited to, application circuitry 1002, RF circuitry 1006, or FEM circuitry 1008.

Processors of the application circuitry 1002 and processors of the baseband circuitry 1004 can be used to execute elements of one or more instances of a protocol stack. For example, processors of the baseband circuitry 1004, alone or in combination, can be used execute Layer 3, Layer 2, or Layer 1 functionality, while processors of the baseband circuitry 1004 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, Layer 2 can comprise a medium access control (MAC) layer, a radio link control (RLC) layer, and a packet data convergence protocol (PDCP) layer, and Layer 1 can comprise a physical (PHY) layer of a UE/RAN node.

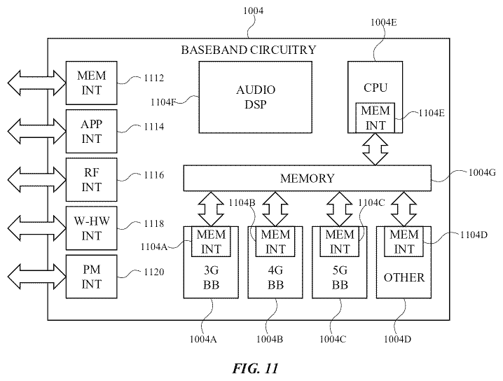

FIG. 11 is a diagram of example interfaces of baseband circuitry according to one or more implementations described herein. As discussed above, the baseband circuitry 1004 of FIG. 10 can comprise processors 1004A-1004E and a memory 1004G utilized by said processors. The processors 1004A-1004E may collectively referred as a baseband processor. Each of the processors 1004A-1004E can include a memory interface, 1104A-1104E, respectively, to send/receive data to/from the memory 1004G. In some aspects, the baseband circuitry 1004 or its components, such as the baseband processor, can also be or be included in a UE such as the transmitting UE 110-1 or the receiving UE 110-2 as described throughout this disclosure.

The baseband circuitry 1004 can further include one or more interfaces to communicatively couple to other circuitries/devices, such as a memory interface 1112 (e.g., an interface to send/receive data to/from memory external to the baseband circuitry 1004), an application circuitry interface 1114 (e.g., an interface to send/receive data to/from the application circuitry 1002 of FIG. 10), an RF circuitry interface 1116 (e.g., an interface to send/receive data to/from RF circuitry 1006 of FIG. 10), a wireless hardware connectivity interface 1118 (e.g., an interface to send/receive data to/from Near Field Communication (NFC) components, Bluetooth components, Wi-Fi components, and other communication components), and a power management interface 1120 (e.g., an interface to send/receive power or control signals to/from the PMC 1012).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is an apparatus for a UE, and comprising a memory and a processor coupled to the memory, and when executing instructions stored in the memory, configured to cause the UE to sense and select resources, based on a clear channel assessment (CCA) operation to be performed, for sidelink communication on unlicensed band (SL-U), perform the CCA operation for SL-U, and transmitting data to another UE using the selected resources for the SL-U.

Example 2 is an apparatus, including the subject matter of Example 1, wherein the selection of the resources comprises determining a resource selection window based on an expected CCA time of the CCA operation.

Example 3 is an apparatus, including the subject matter of Example 2, wherein the expected CCA time of the CCA operation is calculated based on a channel access priority class (CAPC) value of the data to be transmitted and a current contention window size (“CW_p”) of the CCA operation.

Example 4 is an apparatus, including the subject matter of any of Example 2-3, wherein the resource selection window has a lower bound as between the expected CCA time and a sum of the expected CCA time and a processing time Tproc, 1 required for the resource selection for SL-U.

Example 5 is an apparatus, including the subject matter of Example 3, wherein the expected CCA time of the CCA operation is a sum of a deferral duration of the CCA operation based on the CAPC value and an estimated back-off period of the CCA operation related to the current contention window size (“CW_p”).

Example 6 is an apparatus, including the subject matter of Example 5, wherein the estimated back off period of the CCA operation is N*sensing slot period, wherein N is a back-off counter randomly selected by the CCA operation between 0 and the current contention window size (“CW_p”).

Example 7 is an apparatus, including the subject matter of any of Example 3 or 5, wherein the expected CCA time of the CCA operation is calculated based on a channel occupancy rate (Roc).

Example 8 is an apparatus, including the subject matter of Example 7, wherein the channel occupancy rate (Roc) is defined as a percentage of samples with a received signal strength indicator (RSSI) measurement, measured in a measurement window, meeting a channel occupancy threshold.

Example 9 is an apparatus, including the subject matter of Example 7, wherein the channel occupancy rate (Roc) is defined as a percentage of sensing slots that are identified as occupied slots, by the CCA operation, among a number total sensing slots within a predefined time window.

Example 10 is an apparatus, including the subject matter of Example 7, wherein the expected CCA time of the CCA operation is calculated as 16 μs+m*9 μs+N*9μs/(1−Roc), where m is an integer number related to the CAPC value, and N is another integer number randomly selected by the CCA operation between 0 and the current contention window size (“CW_p”).

Example 11 is an apparatus, including the subject matter of Example 2, wherein the resource selection window has an upper bound as greater than a sum of a minimum selection period and the expected CCA time, but not exceeding a remaining packet delay budget (PDB).

Example 12 is an apparatus, including the subject matter of Example 11, wherein the expected CCA time is set as Td+CW_p, where Td is a deferral period of the CCA operation, and CW_p is a current contention window size of the CCA operation.

Example 13 is an apparatus, including the subject matter of Example 11, wherein the expected CCA time is set as Td+CW_p/(1−Roc), where Td is a deferral period of the CCA operation, CW_p is a current contention window size of the CCA operation, and Roc is a channel occupancy rate.

Example 14 is an apparatus, including the subject matter of Example 1, wherein the selection of the resources comprises determining a resource selection window, and obtaining an initial set of candidate resources and excluding candidates to form a set of adjusted candidate resources, based on an indication of consistent listen-before-talk (LBT) failure.

Example 15 is an apparatus, including the subject matter of Example 14, wherein the indication of consistent LBT failure is provided from a MAC layer to a physical layer per RB set.

Example 16 is an apparatus, including the subject matter of Example 15, wherein the processor is further configured to cause the UE to determine a number of remaining candidate resources of the set of adjusted candidate resources smaller than a predefined threshold, notify candidate insufficiency to the MAC layer, and perform a resource pool reelection by the MAC layer.

Example 17 is an apparatus, including the subject matter of Example 1, wherein the processor is configured to cause the UE to receive, from an initialing UE, Sidelink Control Information (SCI) including a shared Channel Occupancy Time (COT) information, wherein the shared COT information includes information of a shared COT initiated by the initialing UE. The selection of the resources comprises determining a resource selection window with a start time and an ending time, wherein the ending time is not later than a remaining COT duration of the COT and a remaining packet delay budget (PDB).

Example 18 is a method for operating a UE, and the method comprising determining a resource selection window for sidelink communication on unlicensed band (SL-U), obtaining an initial set of candidate resources within the resource selection window, excluding one or more resource blocks, based on an indication of consistent listen-before-talk (LBT) failure from a MAC layer, from the initial set of candidate resources to form a set of adjusted candidate resources, selecting resources from the set of adjusted candidate resources, and transmitting data to another UE using the selected resources.

Example 19 is a method, including the subject matter of Example 18, and further comprising determining a number of remaining candidate resources of the set of adjusted candidate resources smaller than a predefined threshold, notifying candidate insufficiency to the MAC layer, and performing a resource pool reelection by the MAC layer.

Example 20 is a baseband process for a UE, and comprising a memory and a processor coupled to the memory, and when executing instructions stored in the memory, configured to cause the UE to receive, from an initialing UE, Sidelink Control Information (SCI) including a shared Channel Occupancy Time (COT) information, wherein the shared COT information includes information of a shared COT initiated by the initialing UE, determine a resource selection window for sidelink communication on an unlicensed spectrum (SL-U) with an ending time no later than a remaining COT duration of the COT or a remaining packet delay budget (PDB), select resources for SL-U during the resource selection window, and transmit, using the selected resources for SL-U, data to the initialing UE.

Example 21 is a method that includes any action or combination of actions as substantially described herein in the Detailed Description.

Example 22 is a method as substantially described herein with reference to each or any combination of the Figures included herein or with reference to each or any combination of paragraphs in the Detailed Description.

Example 23 is a user equipment configured to perform any action or combination of actions as substantially described herein in the Detailed Description as included in the user equipment.

Example 24 is a network node configured to perform any action or combination of actions as substantially described herein in the Detailed Description as included in the network node.

Example 25 is a non-volatile computer-readable medium that stores instructions that, when executed, cause the performance of any action or combination of actions as substantially described herein in the Detailed Description.

Example 26 is a baseband processor of a user equipment configured to perform any action or combination of actions as substantially described herein in the Detailed Description as included in the user equipment.

Example 27 is a baseband processor of a network node configured to perform any action or combination of actions as substantially described herein in the Detailed Description as included in the user equipment.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. An apparatus for a User Equipment (UE), comprising:
a memory configured to store instructions; and
a processor coupled to the memory configured to execute the instructions to cause the UE to:
select resources, for a sidelink unlicensed band (SL-U) communication on an unlicensed band, by obtaining an initial set of candidate resources and adjusting the set based on an indication of consistent listen-before-talk (LBT) failures;
perform a clear channel assessment (CCA) operation on the selected resources for the SL-U communication; and
send data to another UE using the selected resources for the SL-U_communication.

2. The apparatus of claim 1, wherein the resources are selected by determining a resource selection window based on an expected CCA time of the CCA operation.

3. The apparatus of claim 2, wherein the expected CCA time of the CCA operation is calculated based on a channel access priority class (CAPC) value of the data to be transmitted and a current contention window size (“CW_p”) of the CCA operation.

4. The apparatus of claim 2, wherein the resource selection window has a lower bound as between the expected CCA time and a sum of the expected CCA time and a processing time Tproc,1 required for the resource selection for the SL-U communication.

5. The apparatus of claim 3, wherein the expected CCA time of the CCA operation is a sum of a deferral duration of the CCA operation based on the CAPC value and an estimated back-off period of the CCA operation related to the current contention window size (“CW_p”).

6. The apparatus of claim 5, wherein the estimated back off period of the CCA operation is N*sensing slot period, wherein N is a back-off counter randomly selected by the CCA operation between 0 and the current contention window size (“CW_p”).

7. The apparatus claim 3, wherein the expected CCA time of the CCA operation is calculated based on a channel occupancy rate (Roc).

8. The apparatus of claim 7, wherein the channel occupancy rate (Roc) is defined as a percentage of samples with a received signal strength indicator (RSSI) measurement, measured in a measurement window, meeting a channel occupancy threshold.

9. The apparatus of claim 7, wherein the channel occupancy rate (Roc) is defined as a percentage of sensing slots that are identified as occupied slots, by the CCA operation, among a number total sensing slots within a predefined time window.

10. The apparatus of claim 7, wherein the expected CCA time of the CCA operation is calculated as 16 μs+m*9 μs+N*9μs/(1−Roc), where m is an integer number related to the CAPC value, and N is another integer number randomly selected by the CCA operation between 0 and the current contention window size (“CW_p”).

11. The apparatus of claim 2, wherein the resource selection window has an upper bound as greater than a sum of a minimum selection period and the expected CCA time, but not exceeding a remaining packet delay budget (PDB).

12. The apparatus of claim 11, wherein the expected CCA time is set as Td+CW_p, where Td is a deferral period of the CCA operation, and CW_p is a current contention window size of the CCA operation.

13. The apparatus of claim 11, wherein the expected CCA time is set as Td+CW_p/(1−Roc), where Td is a deferral period of the CCA operation, CW_p is a current contention window size of the CCA operation, and Roc is a channel occupancy rate.

14. The apparatus of claim 1, wherein a candidate resource is excluded from selection provided a parameter indicating consistent LBT failures includes a resource block (RB) set associated with the candidate resource.

15. The apparatus of claim 14, wherein the indication of consistent LBT failure is provided from a MAC layer to a physical layer per RB set.

16. The apparatus of claim 15, further configured to cause the UE to:
determine a number of remaining candidate resources of the set of adjusted candidate resources smaller than a predefined threshold;
notify candidate insufficiency to the MAC layer; and
perform a resource pool reelection by the MAC layer.

17. The apparatus of claim 1, wherein the processor is configured to cause the UE to:
receive, from an initialing UE, Sidelink Control Information (SCI) including a shared Channel Occupancy Time (COT) information, wherein the shared COT information includes information of a shared COT initiated by the initialing UE; and
wherein the selection of the resources comprises determining a resource selection window with a start time and an ending time, wherein the ending time is not later than a remaining COT duration of the COT and a remaining packet delay budget (PDB).

18. A method for operating a User Equipment (UE), comprising:
determining a resource selection window for sidelink unlicensed band (SL-U) communication on an unlicensed band;
obtaining an initial set of candidate resources within the resource selection window;
excluding one or more resource blocks, based on an indication of consistent listen-before-talk (LBT) failures from a higher layer, from the initial set of candidate resources to form a set of adjusted candidate resources;
selecting resources from the set of adjusted candidate resources; and
transmitting data to another UE using the selected resources.

19. The method of claim 18, further comprising:
determining a number of remaining candidate resources of the set of adjusted candidate resources smaller than a predefined threshold;
notifying candidate insufficiency to the higher layer; and
performing a resource pool reelection.

20. A baseband processor for a User Equipment (UE), comprising:
a memory; and
a processor coupled to the memory, and when executing instructions stored in the memory, configured to cause the UE to:
receive, from an initialing UE, Sidelink Control Information (SCI) including a shared Channel Occupancy Time (COT) information, wherein the shared COT information includes information of a shared COT initiated by the initialing UE;
determine a resource selection window for a sidelink unlicensed band (SL-U) communication on an unlicensed band with an ending time no later than a remaining COT duration of the COT or a remaining packet delay budget (PDB);
select resources for the SL-U communication during the resource selection window; and
transmit, using the selected resources for the communication, data to the initialing UE.
